(19) United States
(12) Patent Application Publication
(10) Pub. No.: US 2024/0357205 A1
(43) Pub. Date: Oct. 24, 2024

(54) INFORMATION PROCESSING DEVICE, INFORMATION PROCESSING METHOD, AND NON-TRANSITORY COMPUTER-READABLE STORAGE MEDIUM

(71) Applicant: Sony Group Corporation, Tokyo (JP)

(72) Inventors: Kenta ABE, Kanagawa (JP); Fumihiko IIDA, Kanagawa (JP); Yuji KITAZAWA, Saitama (JP); Rei MINAKAMI, Tokyo (JP)

(73) Assignee: Sony Group Corporation, Tokyo (JP)

(21) Appl. No.: 18/687,828

(22) PCT Filed: Mar. 8, 2022
(86) PCT No.: PCT/JP2022/009854

§ 371 Date: Feb. 29, 2024

(30) Foreign Application Priority Data
Sep. 7, 2021 (JP) 2021-145096

(51) Int. Cl. H04N 21/472

(52) U.S. Cl. CPC H04N 21/472

(57) ABSTRACT

An information processing device according to the present disclosure includes: a video information acquisition unit that acquires video information on a video at a first timing at which a streamed video is presented to a viewer; a viewer information acquisition unit that acquires viewer information which is information on the viewer; and a processing unit that performs distribution processing for distributing a consideration, provided to the video by the viewer, to multiple subjects based on the video information and the viewer information.

### FIELD

The present disclosure relates to an information processing device, an information processing method, and a non-transitory computer-readable storage medium.

### BACKGROUND

With the development of high-speed communication networks, video streaming such as music live shows has become active. In such video streaming, in order to give a realistic feeling and a sense of unity that can be experienced at a live site to a user (viewer) viewing a video, a method of feeding back information, such as support from the viewer, to the site using an information terminal has been proposed (for example, Patent Literature 1).

For example, a throwing money (registered trademark) system has been known which provides, as one piece of information from a viewer, a reward (consideration) from the viewer to a subject providing a video such as a performer appearing in the video.

### CITATION LIST

### Patent Literature

Patent Literature 1: JP 2005-339479 A

### SUMMARY

### Technical Problem

However, the prior art does not take into consideration of distribution of a consideration provided by a viewer. For example, in the throwing money system, the destination to which the consideration provided by the viewer will belong is ambiguous. It is therefore requested to appropriately distribute the consideration provided by the viewer.

Thus, the present disclosure proposes an information processing device, an information processing method, and a non-transitory computer-readable storage medium capable of appropriately distributing a consideration provided by a viewer.

### Solution to Problem

According to the present disclosure, an information processing device includes a video information acquisition unit that acquires video information on a video at a first timing at which a streamed video is presented to a viewer, a viewer information acquisition unit that acquires viewer information which is information on the viewer; and a processing unit that performs distribution processing for distributing a consideration, provided to the video by the viewer, to a plurality of subjects based on the video information and the viewer information.

### BRIEF DESCRIPTION OF DRAWINGS

FIG. 1 is a diagram illustrating an example of information processing according to an embodiment of the present disclosure.

FIG. 2 is a diagram illustrating a configuration example of an information processing system according to the embodiment of the present disclosure.

FIG. 3 is a diagram illustrating a configuration example of an information processing device according to the embodiment of the present disclosure.

FIG. 4 is a diagram illustrating an example of a weight information storage unit according to the embodiment of the present disclosure.

FIG. 5 is a diagram illustrating a configuration example of a terminal device according to the embodiment of the present disclosure.

FIG. 6 is a flowchart illustrating a processing procedure of the information processing device according to the embodiment of the present disclosure.

FIG. 7 is a flowchart illustrating a procedure related to distribution processing.

FIG. 8 is a diagram illustrating an example of a partial distribution rate.

FIG. 9 is a diagram illustrating an example of weighting.

FIG. 10 is a diagram illustrating an example of the distribution processing.

FIG. 11 is a diagram illustrating an example of a first pattern related to payment timing.

FIG. 12 is a diagram illustrating an example of a second pattern related to payment timing.

FIG. 13 is a hardware configuration diagram illustrating an example of a computer that implements functions of the information processing device.

### DESCRIPTION OF EMBODIMENTS

Hereinafter, embodiments of the present disclosure will be described in detail with reference to the drawings. Note that, an information processing device, an information processing method, and a non-transitory computer-readable storage medium according to the present application are not limited to those of the embodiments. In addition, in the following embodiments, the same parts are denoted by the same reference signs to omit redundant description.

The present disclosure will be described according to the following order of items.
1. Embodiment
1-1. Overview of Information Processing According to Embodiment of Present Disclosure
1-1-1. Effects Etc.
1-2. Configuration of Information Processing System According to Embodiment
1-3. Configuration of Information Processing Device According to Embodiment
1-4. Configuration of Terminal Device According to Embodiment
1-5. Procedure of Information Processing According to Embodiment
1-6. Processing Example
1-6-1. Mode
1-6-2. Subject (Distribution Destination)
1-6-3. Partial Distribution Rate (Promoter, Video, Viewer)
1-6-4. Weighting
1-6-5. Distribution Processing Example
1-6-6. Another Distribution Processing Example (Third Mode Etc.)
1-6-7. Distribution Rate Determination Example (Designation of Viewer)
1-7. Determination of Timing When Video Is Referenced
1-7-1. First Example
1-7-2. Second Example
1-8. Payment Timing Example
1-8-1. First Pattern
1-8-2. Second Pattern
2. Other Embodiments
2-1. Other Configuration Examples
2-2. Others
3. Effects According to Present Disclosure
4. Hardware Configuration

### 1. Embodiment

### [1-1. Overview of Information Processing According to Embodiment of Present Disclosure]

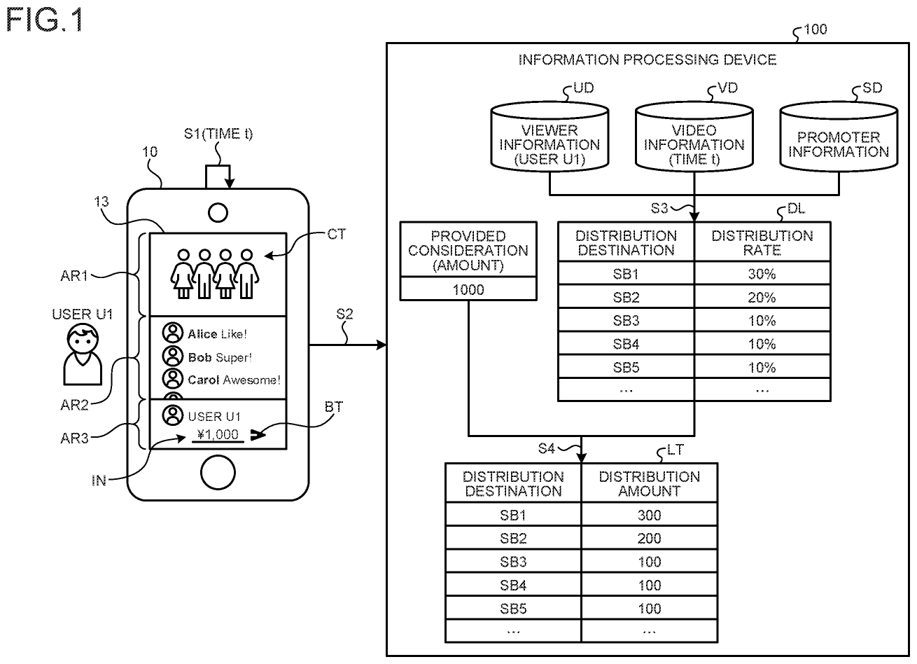

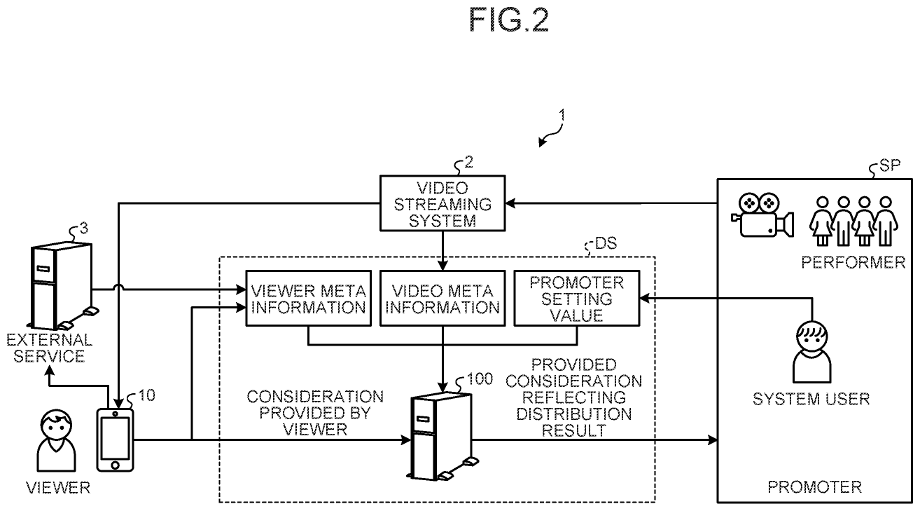

FIG. 1 is a diagram illustrating an example of information processing according to an embodiment of the present disclosure. The information processing according to the embodiment of the present disclosure is implemented by an information processing system 1 (see FIG. 2) including an information processing device 100 and a terminal device 10.

In FIG. 1, a case where a consideration (also referred to as a “provided consideration”) provided by a user U1 who is a user (also referred to as a “viewer”) viewing a video is distributed will be described as an example. Note that, the consideration mentioned here may be any consideration as long as the user (viewer) viewing the video provides the consideration as a reward (consideration) for the video and the consideration can be a distribution processing target. The consideration mentioned here is not limited to money (amount of money) directly provided by the viewer via a network by way of so-called throwing money or the like, and may be a paid item, a paid gift, and the like provided by the user and converted into a monetary value (amount of money), for example.

FIG. 1 illustrates a case where the destination to which the provided consideration from a viewer is to be distributed is a promoter of a video. The promoter of the video is a subject related to provision of the video, and includes, for example, a cast (also referred to as a “performer”) of the video, an office (organization) to which the cast of the video belongs, an event promoter of the video, and the like. Note that, the above is merely an example, and the promoter (distribution destination) of the video may include various subjects, which will be described later. In FIG. 1, the distribution processing is executed with multiple subjects such as the performer of the video set as the distribution destination.

Hereinafter, an outline of the processing illustrated in FIG. 1 will be described. The information processing system 1 is a system based on the premise that the viewer provides a consideration to a performer. The viewer views a performance of the performer using the terminal device 10 which is an information processing terminal. Then, the viewer provides a consideration (value) to a promoter such as the performer using the terminal device 10. The terminal device 10 in FIG. 1 illustrates an image diagram in which the viewer provides the consideration using the terminal device 10.

FIG. 1 illustrates a case where a video CT of a music live show is streamed to the terminal device 10 used by the user U1. The video CT is streamed from a video streaming system 2 (see FIG. 2) which is a streaming platform. Various pieces of information including the video CT being streamed are displayed on a display unit 13 of the terminal device 10. The terminal device 10 displays the video CT in an area AR1. The terminal device 10 in FIG. 1 illustrates a state where a scene at time t including four performers is displayed in the area AR1 in the video CT.

In addition, the terminal device 10 displays a list of viewer's comments in an area AR2. The terminal device 10 displays, in an area AR3, information for receiving input of a consideration by the user U1. The area AR3 includes an input field IN for inputting the amount of money to be provided as a consideration and a button BT for sending the information processing device 100 information indicating the amount of money input in the input field IN.

The user U1 who is viewing the video CT inputs the amount of money to be provided as a consideration into the input field IN in the area AR3. In FIG. 1, the user U1 operates the terminal device 10 to input the amount “1000” to be provided as a consideration into the input field IN. Then, the user U1 who is viewing video CT selects the button BT while the scene at the time t including the four performers is displayed in the video CT (Step S1). For example, the terminal device 10 accepts provision of the consideration by the user U1 by an operation of the user U1 touching a portion where the button BT is displayed.

In response to the selection of the button BT by the user U1, the terminal device 10 sends the information processing device 100 information (consideration provision information) indicating the provision of the consideration by the user U1 (Step S2). For example, the terminal device 10 sends the information processing device 100 information indicating that the timing at which the user U1 provided the consideration is the time t (first timing) at which the four performers are included in the video CT, and the consideration provision information indicating that the provided consideration is equal to the amount “1000”.

The information processing device 100 having received the consideration provision information from the terminal device 10 executes distribution processing. The information processing device 100 calculates the distribution rate using viewer information UD of the user U1 who has provided the consideration, video information VD of the video CT at the time t which is the first timing, and promoter information SD of the video CT (Step S3). For example, the viewer information UD includes an action history of the user U1, information indicating preference of the user U1, and the like. For example, the video information VD includes information indicating casts included in the video CT at the first timing. Meanwhile, the promoter information SD includes information such as information set by the promoter. Note that, details of the viewer information, the video information, and the promoter information will be described later.

The information processing device 100 calculates the distribution rate of each subject using the viewer information UD, the video information VD, and the promoter information SD. In FIG. 1, the information processing device 100 calculates the distribution rate of each of multiple subjects such as subjects SB1 to SB5 as illustrated in a distribution rate list DL. For example, the information processing device 100 calculates the distribution rate of the subject SB1 as “30%” (0.3), the distribution rate of the subject SB2 as “20%”, the distribution rate of the subject SB3 as “10%”, the distribution rate of the subject SB4 as “10%”, and the distribution rate of the subject SB5 as “10%”. For example, the information processing device 100 calculates three partial distribution rates on the basis of information on each of the promoter, the video, and the viewer, and calculates the distribution rate using the three partial distribution rates, which will be described later.

In FIG. 1, each subject is represented in an abstract form such as the “subject SB1”, but any information may be used as long as the subject serving as the distribution destination can be identified by the information, and information indicating specific names such as a performer A, an office F, and the like may be used, for example. For example, the subjects SB1 to SB4 may be the four performers included in the video CT at the time t, and the subject SB5 may be an event promoter of the video CT. Note that, the multiple subjects (distribution destinations) such as the subjects SB1 to SB5 may be identified by the information processing device 100 on the basis of the video information VD or the like, or may be set by the promoter information SD or the like.

Then, the information processing device 100 distributes the amount “1000” as the provided consideration according to the distribution rate of each of the multiple subjects such as the subjects SB1 to SB5 (Step S4). The information processing device 100 distributes the amount “1000” to the subjects by calculating the amount of money to be distributed to each subject out of the amount “1000” using the distribution rate list DL. In FIG. 1, as illustrated in a distribution amount list LT, the information processing device 100 calculates the amount of money to be distributed to each of the multiple subjects such as the subjects SB1 to SB5. The information processing device 100 calculates the amount of money to be distributed to each subject by multiplying the amount “1000” by the distribution rate of this subject. For example, the information processing device 100 calculates the amount of money to be distributed to the subject SB1 as “300 (=0.3×1000)”, the amount of money to be distributed to the subject SB2 as “200”, and the amount of money to be distributed to each of the subjects SB3 to SB5 as “100”.

Note that, FIG. 1 illustrates as an example the case where the amount of money (designated amount) designated by the viewer is directly set as the distribution target. However, the amount of money obtained by subtracting a fee to the streaming platform distributing the video from the designated amount may be set as the distribution target. In other words, the consideration mentioned here may be the amount of money obtained by subtracting the fee to the streaming platform. Note that, the streaming platform may be included in the distribution destination. In this case, the information processing device 100 may perform the distribution processing on the amount of money (designated amount) designated by the viewer with multiple subjects including the streaming platform set as the distribution destination.

### [1-1-1. Effects Etc.]

As described above, the information processing device 100 can appropriately distribute the consideration provided by the viewer by distributing the value provided by the viewer in consideration of the information on the video, the viewer, and the like at the timing when the viewer provides the consideration. For example, in an event created by multiple performers, it is possible to comprehend to which performer or performance and at what timing the viewer has provided the value, and distribute the value in consideration of that information, thus making it possible to perform information processing of distributing the provided value appropriately. For example, the information processing device 100 can distribute the consideration provided by the viewer in consideration of meta information accompanying the viewer and the intention of the promoter.

### [1-2. Configuration of Information Processing System According to Embodiment]

The information processing system 1 illustrated in FIG. 2 will be described. As illustrated in FIG. 2, the information processing system 1 includes the video streaming system 2, an external service device 3, the terminal device 10, and a distribution system DS. The devices included in the information processing system 1 are connected by wire or radio via a predetermined communication network (such as the Internet) so as to be capable of communicating with each other. Note that, FIG. 2 is merely an example, and the information processing system 1 may include a device (payment server) or the like of a payment system 5 to be described later.

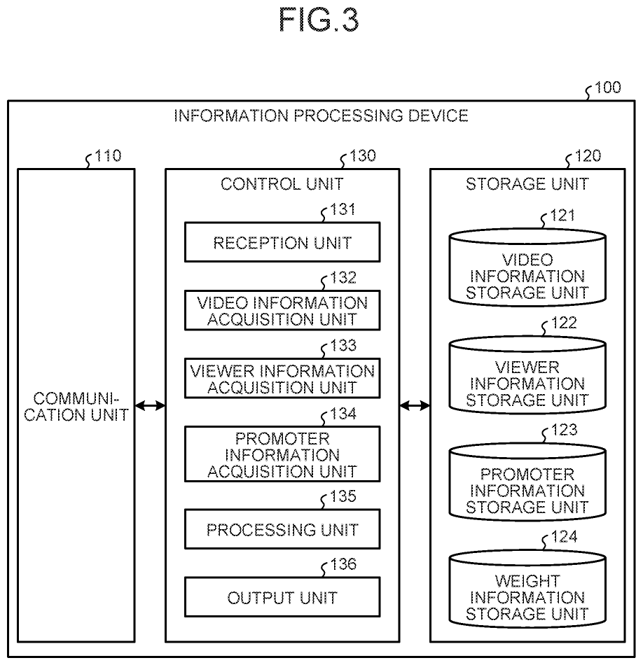

The distribution system DS includes devices such as the information processing device 100, a device (viewer information database) that stores the viewer information such as viewer meta information, a device (video information database) that stores the video information such as video meta information, and a device (promoter information database) that stores the promoter information such as a promoter setting value. Note that, in FIG. 3, a configuration where the information processing device 100 stores the viewer information, the video information, and the promoter information will be described as an example.

In addition, the information processing system 1 may include a device (promoter device) used by a system user (such as an event promoter) on a promoter SP side. For example, the promoter device may be a device such as a notebook personal computer (PC), a desktop PC, a smartphone, a tablet terminal, a mobile phone, or a personal digital assistant (PDA). For example, the system user on the promoter SP side performs setting of various types of information and the like by operating the promoter device. The system user on the promoter SP side can manually input a distribution setting value. In addition, the system user on the promoter SP side can change the weighting of the distribution.

The video streaming system 2 is a system that provides a video streaming service. For example, the video streaming system 2 includes a streaming server that is a computer used to perform video streaming. The video streaming system 2 receives a camera video including audio as an input, and streams the camera video to the viewer. The video streaming system 2 analyzes the video in real time to give meta information such as who is shown at what time and which effect occurs in the video, and stores the information in the database in the distribution system DS as video meta information together with time information. The meta information includes time, a person, a song, a musical instrument, an effect, and information related thereto.

The external service device 3 is a device that provides the user with a service different from the video streaming service provided by the video streaming system 2. For example, the external service device 3 provides a social networking service (SNS) service. Note that, the service provided by the external service device 3 is not limited to the SNS service, and may be, for example, a service that streams various information such as an e-commerce service, an electronic payment service, a search service, a news streaming service, or a web blog service. For example, the external service device 3 collects an action history of the user and provides the collected action history of the user to another device such as the information processing device 100.

The viewer (user) operates the terminal device 10 to receive the video in which the performer appears from the promoter SP side via the video streaming system 2. The terminal device 10 is a device used by the user. The terminal device 10 receives an input by the user. The terminal device 10 may be any device as long as it can perform processing according to the embodiment. For example, the terminal device 10 may be a device such as a smartphone, a tablet terminal, a notebook PC, a desktop PC, a mobile phone, or a PDA.

The terminal device 10 transmits the viewer meta information to the distribution system DS. The distribution system DS stores the information in a database (for example, the viewer information database or a viewer information storage unit 122). In addition, the distribution system DS may also refer to a history of an external service normally used by the user, for example, if the user approves it. The viewer meta information includes history information on viewing, screen selection, purchase, and the like, and information related thereto. For example, the viewer meta information may include the number of feedbacks to a specific performer, the number of times of viewing a video, a browsing history of related information, a purchase history of a good, and the like. For example, the information processing device 100 of the distribution system DS acquires information, indicating the viewer's action history and the viewer's preference, from the external service device 3 that provides the SNS service or the like.

The information processing device 100 is a computer that executes distribution processing for distributing a consideration provided by the viewer to multiple subjects on the basis of the video information and the viewer information related to a video. Note that, the distribution processing may be any processing as long as it relates to processing of distributing a consideration to multiple subjects. For example, the processing may be processing of distributing the consideration to the multiple subjects or processing of determining the distribution rate of each of the multiple subjects. The information processing device 100 receives various types of information from the terminal device 10, the video streaming system 2, and the external service device 3. Further, the information processing device 100 transmits various types of information to the terminal device 10 and the promoter device.

The information processing device 100 refers to all of the value set by the promoter, the meta information extracted by analyzing the video, and the meta information including the viewer's preference information, and performs calculation necessary for distributing the consideration.

The information processing device 100 reflects the calculation result (distribution result) in the provided consideration from the viewer and outputs it to the promoter SP side. For example, the information processing device 100 transmits the distribution result to the promoter device. Here, the information processing device 100 may transmit the distribution result to the payment system 5. Note that, the timing of transmission to the payment system 5 will be described later.

### [1-3. Configuration of Information Processing Device According to Embodiment]

Next, a configuration of the information processing device 100 that is an example of an information processing device that executes information processing according to the embodiment will be described. FIG. 3 is a diagram illustrating a configuration example of the information processing device according to the embodiment of the present disclosure.

As illustrated in FIG. 3, the information processing device 100 includes a communication unit 110, a storage unit 120, and a control unit 130. Note that, the information processing device 100 may include an input unit (such as a keyboard and a mouse) that receives various operations from an administrator or the like of the information processing device 100, and a display unit (such as a liquid crystal display) for displaying various types of information.

The communication unit 110 is implemented by, for example, a network interface card (NIC) and the like. The communication unit 110 is connected to a network by wire or radio, and transmits and receives information to and from each device included in the information processing system 1. For example, the communication unit 110 transmits and receives information to and from the terminal device 10, a device (such as the promoter device) used by the system user who provides the video, a device (such as the streaming server) of the video streaming system 2, the external service device 3, and the like.

The storage unit 120 is implemented by, for example, a semiconductor memory element such as a random access memory (RAM) and a flash memory, or a storage device such as a hard disk and an optical disk. As illustrated in FIG. 3, the storage unit 120 according to the embodiment includes a video information storage unit 121, the viewer information storage unit 122, a promoter information storage unit 123, and a weight information storage unit 124.

The video information storage unit 121 according to the embodiment stores various types of information regarding the streamed video. The video information storage unit 121 stores the video information including video meta information. The video information storage unit 121 stores the video information provided from the video streaming system 2.

The video information storage unit 121 stores video meta information of a video including time, a person, a song, a musical instrument, and an effect, and information related thereto. The video information storage unit 121 stores the person, the song, the musical instrument, and the effect in the video and the information related thereto in association with the time information.

For example, the video information storage unit 121 stores the video information including video meta information indicating who appears at what time in the video. For example, the video information storage unit 121 stores the video information including video meta information indicating which effect occurs at what time in the video.

The video information storage unit 121 stores the video information including information indicating the cast in the video. The video information storage unit 121 stores the video information including information indicating the cast included in the video at the first timing. The video information storage unit 121 may store a distribution rate (video reference distribution rate) calculated based on the video information.

Note that, although FIG. 3 illustrates an example where the information processing device 100 includes the video information storage unit 121, a video information database that stores information stored in the video information storage unit 121 may be provided in the distribution system DS. In this case, the information processing device 100 may acquire the video information without including the video information storage unit 121 by communicating with the video information database.

The viewer information storage unit 122 according to the embodiment stores various types of information regarding the viewer (user). The viewer information storage unit 122 stores the viewer information including viewer meta information. The viewer information storage unit 122 stores the viewer information provided from the viewer himself/herself or the external service device 3.

The viewer information storage unit 122 stores viewer meta information including history information on various actions performed by the viewer, such as viewing, screen selection, and purchase, and information related thereto. The viewer information storage unit 122 stores the viewer's actions in the SNS service.

The viewer information storage unit 122 stores the viewer information including an action history of the viewer. The viewer information storage unit 122 stores the viewer information including information indicating the preference of the viewer. The viewer information storage unit 122 may store a distribution rate (viewer reference distribution rate) calculated on the basis of the viewer information.

Note that, although FIG. 3 illustrates an example where the information processing device 100 includes the viewer information storage unit 122, a viewer information database that stores information stored in the viewer information storage unit 122 may be provided in the distribution system DS. In this case, the information processing device 100 may acquire the viewer information without including the viewer information storage unit 122 by communicating with the viewer information database.

The promoter information storage unit 123 according to the embodiment stores various types of information regarding the promoter. The promoter information storage unit 123 may store promoter meta information. The video information storage unit 121 stores the promoter information provided from the promoter.

The promoter information storage unit 123 stores the promoter information including the setting by the promoter. For example, the promoter information storage unit 123 stores a distribution rate (promoter reference distribution rate) set by the promoter. In addition, the promoter information storage unit 123 may store a distribution rate (promoter reference distribution rate) calculated on the basis of the promoter information.

Note that, although FIG. 3 illustrates an example where the information processing device 100 includes the promoter information storage unit 123, a promoter information database that stores information stored in the promoter information storage unit 123 may be provided in the distribution system DS. In this case, the information processing device 100 may acquire the promoter information without including the promoter information storage unit 123 by communicating with the promoter information database.

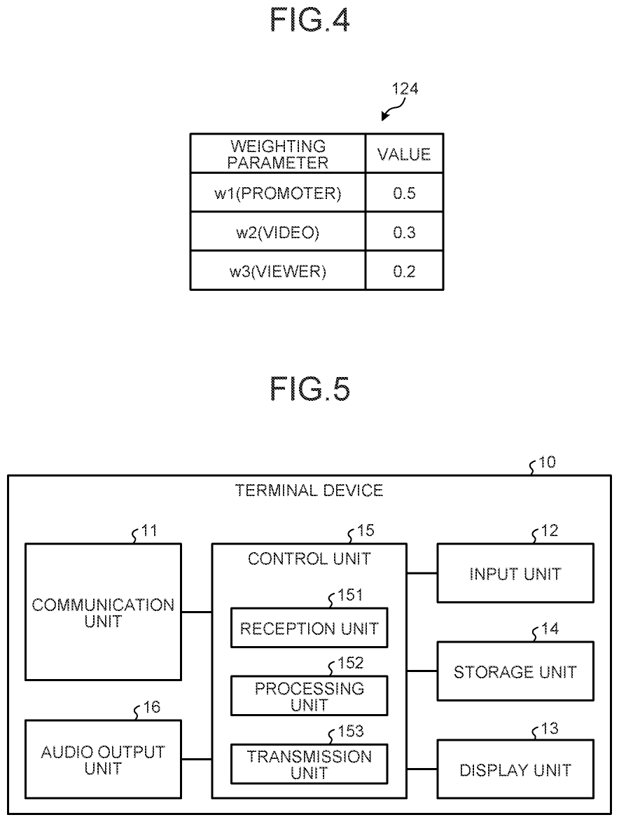

The weight information storage unit 124 according to the embodiment stores information regarding the weight. For example, the weight information storage unit 124 stores information regarding multiple weighting parameters. FIG. 4 is a diagram illustrating an example of the weight information storage unit according to the embodiment of the present disclosure. In the example illustrated in FIG. 4, the weight information storage unit 124 includes items such as “weighting parameter” and “value”.

The “weighting parameter” indicates a weighting parameter (weight parameter) corresponding to each target. The “value” indicates a value (numerical value) of each weighting parameter.

FIG. 4 indicates that the value of a weighting parameter w1 corresponding to the promoter is “0.5.” In addition, it indicates that the value of a weighting parameter w2 corresponding to the video is “0.3.” Further, it is indicated that the value of a weighting parameter w3 corresponding to the viewer is “0.2.”

Note that, information stored in the weight information storage unit 124 is not limited to the above, and the weight information storage unit may store various types of information according to the purpose. For example, information stored in the weight information storage unit 124 is not limited to the above three weighting parameters w1 to w3, and the weight information storage unit may store four or more weighting parameters.

Returning to FIG. 3, the description will be continued. The control unit 130 is implemented by, for example, a central processing unit (CPU), a micro processing unit (MPU), or the like executing a program (such as an information processing program according to the present disclosure) stored in the information processing device 100 with a random access memory (RAM) or the like used as a work area. Further, the control unit 130 is implemented by, for example, an integrated circuit such as an application specific integrated circuit (ASIC) or a field programmable gate array (FPGA).

As illustrated in FIG. 3, the control unit 130 includes a reception unit 131, a video information acquisition unit 132, a viewer information acquisition unit 133, a promoter information acquisition unit 134, a processing unit 135, and an output unit 136, and implements or executes a function and an action of information processing to be described later. Note that, the internal configuration of the control unit 130 is not limited to the configuration illustrated in FIG. 3, and may be another configuration as long as this configuration is for performing information processing to be described later. Further, the connection relationship between the processing units included in the control unit 130 is not limited to the connection relationship illustrated in FIG. 3, and may be another connection relationship.

The reception unit 131 receives various types of information from an external information processing device such as the terminal device 10. The reception unit 131 receives, from the terminal device 10, information input to the terminal device 10. The reception unit 131 receives, from the terminal device 10, information indicating the amount of provided consideration and the destination to which the provided consideration is to be provided which are input to the terminal device 10.

The reception unit 131 receives a consideration provided by the viewer. The reception unit 131 receives information indicating the destination, to which the consideration is to be provided, designated by the viewer. The reception unit 131 receives information indicating the cast, included in the video, designated by the viewer.

The video information acquisition unit 132 acquires the video information. The video information acquisition unit 132 receives the video information from a device (such as the streaming server) of the video streaming system 2. The video information acquisition unit 132 stores the received video information in the video information storage unit 121. The video information acquisition unit 132 acquires the video information from the video information storage unit 121.

The video information acquisition unit 132 acquires the video information on the video at the first timing at which the streamed video is presented to the viewer. The video information acquisition unit 132 acquires the video information including information indicating the cast in the video. The video information acquisition unit 132 acquires the video information including information indicating the cast included in the video at the first timing.

The viewer information acquisition unit 133 acquires the viewer information. The viewer information acquisition unit 133 receives the viewer information from the terminal device 10 used by the user (viewer). The viewer information acquisition unit 133 receives the viewer information from the external service device 3. The viewer information acquisition unit 133 stores the received viewer information in the viewer information storage unit 122. The viewer information acquisition unit 133 acquires viewer information from the viewer information storage unit 122.

The viewer information acquisition unit 133 acquires the viewer information which is information on the viewer. The viewer information acquisition unit 133 acquires the viewer information including an action history of the viewer. The viewer information acquisition unit 133 acquires the viewer information including information indicating the preference of the viewer.

The promoter information acquisition unit 134 acquires the promoter information. The promoter information acquisition unit 134 receives the promoter information from the device (promoter device) used by the promoter. The promoter information acquisition unit 134 receives the promoter information from the promoter device used by the system user (such as the event promoter) who provides the video. The promoter information acquisition unit 134 stores the received promoter information in the promoter information storage unit 123. The promoter information acquisition unit 134 acquires the promoter information from the promoter information storage unit 123.

The promoter information acquisition unit 134 acquires the promoter information related to the promoter of the video. The promoter information acquisition unit 134 acquires the promoter information including the setting by the promoter.

The processing unit 135 executes various types of processing related to video streaming. The processing unit 135 executes distribution processing. The processing unit 135 executes the distribution processing using the information stored in the storage unit 120. The processing unit 135 executes the distribution processing using the information acquired by the video information acquisition unit 132, the viewer information acquisition unit 133, and the promoter information acquisition unit 134.

The processing unit 135 performs the distribution processing for distributing the consideration, provided to the video by the viewer, to multiple subjects based on the video information and the viewer information. The processing unit 135 performs the distribution processing for distributing the consideration, provided to the video by the viewer at the first timing, to the multiple subjects on the basis of the video information and the viewer information. The processing unit 135 distributes the consideration to the multiple subjects, which provide the video, on the basis of the video information and the viewer information. The processing unit 135 distributes the consideration to the multiple subjects including at least one of the cast in the video, the organization to which the cast in the video belongs, and the event promoter of the video.

The processing unit 135 distributes the consideration on the basis of information indicating the cast in the video. The processing unit 135 distributes the consideration on the basis of information indicating the cast included in the video at the first timing. The processing unit 135 determines the first timing based on biological information of the viewer. The processing unit 135 determines the first timing based on biological information of the viewer acquired by a sensor. The processing unit 135 determines, as the first timing, the timing at which the biological information exceeds a predetermined value.

The processing unit 135 distributes the consideration based on the action history of the viewer. The processing unit 135 distributes the consideration based on the information indicating the preference of the viewer. The processing unit 135 calculates a distribution rate of the consideration based on the video information and the viewer information, and distributes the consideration on the basis of the calculated distribution rate of the consideration.

The processing unit 135 calculates the distribution rate of the consideration using a video partial distribution rate (first distribution rate) which is the partial distribution rate calculated on the basis of the video information and a viewer partial distribution rate (second distribution rate) which is the partial distribution rate calculated on the basis of the viewer information. The processing unit 135 calculates the distribution rate of the consideration using information indicating the weights of the first distribution rate ( ) and the second distribution rate. The processing unit 135 calculates the distribution rate of the consideration by using a first weighting parameter indicating the weight of the first distribution rate and a second weighting parameter indicating the weight of the second distribution rate.

The processing unit 135 calculates the video partial distribution rate using the video information including the video meta information etc. The processing unit 135 calculates the video partial distribution rate using the video information (also referred to as “target video information”) related to the video. For example, the target video information includes information indicating a proportion (area) of the performer, appearing in the video at the first timing, in the video. The processing unit 135 sets an initial distribution rate of each subject (distribution destination). For example, the processing unit 135 sets a value, obtained by dividing the total value (100%) by the number of distribution destinations, as the initial distribution rate of each distribution destination. For example, in a case where the number of distribution destinations is “4”, the processing unit 135 sets the initial distribution rate of each distribution destination to “25% (=100/4)”.

For example, in a case where multiple performers are included in the distribution destination, the information processing device 100 adjusts the distribution ratio between the performers according to the proportion of each performer occupied in the video at the first timing. For example, in a case where two performers consisting of a first performer and a second performer are included in the distribution destination and the proportion of the two performers occupied in the video at the first timing is “8:2”, the information processing device 100 adjusts the distribution ratio so that the distribution ratio is higher in the order of the first performer and the second performer. In this case, the information processing device 100 may calculate the distribution rate of the first performer as “40% (=(25+25)*0.8)” and the distribution rate of the second performer as “10% (=50*0.2)”. The processing unit 135 can thereby calculate the video partial distribution rate.

Note that, in the calculation of the video partial distribution rate, in a case where a subject not related to the video (non-video target subject) is included in the distribution destination, the processing unit 135 may set the distribution rate of the non-video target subject to “0%”. For example, in a case where the non-video target subject such as an office (organization) to which the performer belongs or the event promoter is included in the distribution destination, for example, the processing unit 135 may set the distribution rate thereof to “08”. For example, in a case where two non-video target subjects, the office to which the performer belongs and the event promoter, are included in four distribution destinations, the processing unit 135 may set the distribution rate of the office and the event promoter to “0%” and calculate the distribution rate of each of the other two distribution destinations to “50% (=100/2)”.

The above is merely an example, and the processing unit 135 calculates the video partial distribution rate using various information as appropriate. For example, the processing unit 135 may calculate the video partial distribution rate without setting the initial value. For example, the processing unit 135 may calculate the video partial distribution rate using a model (video distribution rate calculation model) that receives the information indicating the distribution destinations and the video information as inputs and outputs the distribution rate of each of the input distribution destinations. In this case, the processing unit 135 may input the information indicating the distribution destinations and the video information to the video distribution rate calculation model, and set the distribution rate of each of the distribution destinations, output by the video distribution rate calculation model, as the video partial distribution rate.

The processing unit 135 calculates the viewer partial distribution rate using the viewer information including the viewer meta information etc. The processing unit 135 sets an initial distribution rate of each subject (distribution destination). For example, the processing unit 135 sets a value, obtained by dividing the total value (100%) by the number of distribution destinations, as the initial distribution rate of each distribution destination. For example, in a case where the number of distribution destinations is “4”, the processing unit 135 sets the initial distribution rate of each distribution destination to “25% (=100/4)”.

The processing unit 135 adjusts the distribution rate of each distribution destination in the viewer partial distribution rate by using the viewer information. For example, the processing unit 135 may presume the performer, production technique, or the like with/in which the viewer is concerned (interested) by analyzing information indicating the action history or preference of the viewer (user), or may acquire information indicating the same (concern target information) from another device. The processing unit 135 adjusts the distribution rate of each distribution destination according to the concern of the viewer presumed from the viewer information. For example, in a case where the viewer is interested in a certain performer (performer X) and the performer X is included in the distribution destination, the processing unit 135 increases the distribution rate of the performer X. For example, the processing unit 135 increases the distribution rate of the performer X by decreasing the distribution rate of three distribution destinations other than the performer X and adding the decreased amount to the distribution rate of the performer X.

For example, the processing unit decreases the distribution rates of the three distribution destinations other than the performer X by “10”, and adds the decreased amount “30 (=10*3)” to the distribution rate of the performer X. Note that, “10” is illustrated here as an example in order to simplify the description, but any decrease value or decrease rate may be set. In this case, the processing unit 135 calculates the distribution rate of the performer X as “55% (=25+30)”, and the distribution rate of each of the other three distribution destinations as “15% (=25-10)”. The processing unit 135 can thereby calculate the viewer partial distribution rate.

The above is merely an example, and the processing unit 135 calculates the viewer partial distribution rate using various information as appropriate. For example, the processing unit 135 may calculate the viewer partial distribution rate without setting the initial value. For example, the processing unit 135 may calculate the viewer partial distribution rate using a model (viewer distribution rate calculation model) that receives the information indicating the distribution destinations and the viewer information as inputs and outputs the distribution rate of each of the input distribution destinations. In this case, the processing unit 135 may input the information indicating the distribution destinations and the viewer information to the viewer distribution rate calculation model, and set the distribution rate of each of the distribution destinations, output by the viewer distribution rate calculation model, as the viewer partial distribution rate.

The processing unit 135 calculates the distribution rate of the consideration by calculating a weighted average using the first distribution rate, the second distribution rate, the first weighting parameter, and the second weighting parameter. The processing unit 135 calculates the distribution rate of the consideration by using the first weighting parameter and the second weighting parameter that are determined based on criteria regarding the video and the viewer.

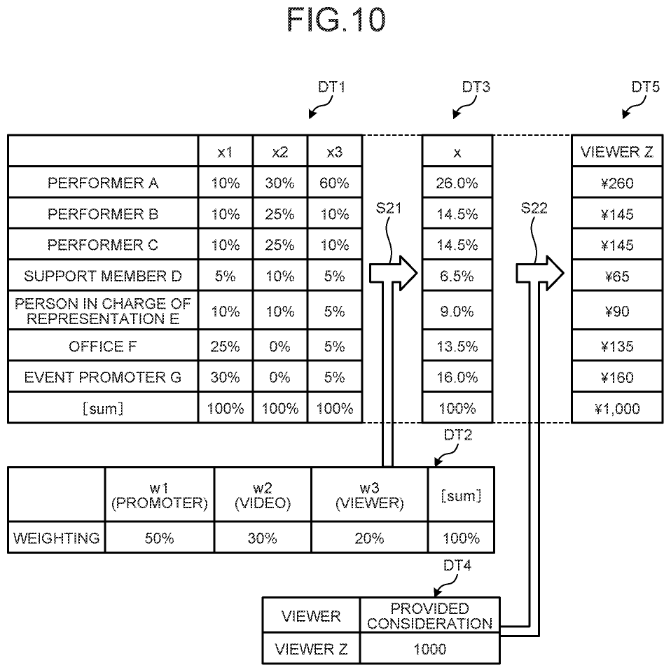

The processing unit 135 distributes the consideration based on the promoter information. The processing unit 135 distributes the consideration based on the setting made by the promoter. The processing unit 135 executes the distribution processing as illustrated in FIG. 10.

The processing unit 135 distributes the consideration from the viewer received by the reception unit 131. The processing unit 135 distributes the consideration while increasing the distribution rate of the destination, to which the consideration is to be provided, designated by the viewer. The processing unit 135 distributes the consideration while increasing the distribution rate of the cast, included in the video, designated by the viewer.

The output unit 136 outputs a processing result of the processing unit 135. The output unit 136 transmits the processing result of the processing unit 135 to the promoter device used by the promoter.

The output unit 136 transmits the processing result of the processing unit 135 to the device (payment server) of the payment system 5. The output unit 136 transmits payment information to the device (payment server) of the payment system 5 at a predetermined timing.

The output unit 136 provides various types of information on the basis of information from the promoter device used by the promoter, the video streaming system 2, the terminal device 10, and the like. The output unit 136 transmits various types of information to another information processing device such as the terminal device 10.

### [1-4. Configuration of Terminal Device According to Embodiment]

Next, a configuration of the terminal device 10 that is an example of an information processing device that executes information processing according to the embodiment will be described. FIG. 5 is a diagram illustrating a configuration example of the terminal device according to the embodiment of the present disclosure.

As illustrated in FIG. 5, the terminal device 10 includes a communication unit 11, an input unit 12, the display unit 13, a storage unit 14, a control unit 15, and an audio output unit 16. Note that, the terminal device 10 may include a sensor that detects (acquires) biological information of the user who uses the terminal device 10 such as the viewer. For example, the terminal device 10 includes a sensor for detecting biological information used for determining the first timing. For example, the terminal device 10 may include various sensors such as a heart rate sensor, a blood pressure sensor, a perspiration sensor, a body temperature sensor, a camera, a microphone, an acceleration sensor, a gyro sensor, and a vibration sensor.

The communication unit 11 is implemented by, for example, an NIC, a communication circuit, or the like. The communication unit 11 is connected to a predetermined communication network (network) by wire or radio, and transmits and receives information to and from each device included in the information processing system 1. For example, the communication unit 11 transmits and receives information to and from the information processing device 100, a device (such as the streaming server) of the video streaming system 2, the external service device 3, and the like.

The input unit 12 receives inputs by various operations of the user. For example, the input unit 12 may receive various operations from the user via a display screen (for example, the display unit 13) by a touch panel function. Further, the input unit 12 may receive various operations through a button provided on the terminal device 10 or a keyboard or a mouse connected to the terminal device 10. The input unit 12 may receive the user's input by voice via a microphone or the like. The input unit 12 receives various operations by the user's utterance.

The input unit 12 receives an operation of providing a consideration by the user. The input unit 12 receives designation of the destination, to which the consideration is to be provided, by the user. The input unit 12 receives designation of the cast, included in the video, by the user.

The display unit 13 displays information. The display unit 13 is a display screen of a tablet terminal or the like implemented by, for example, a liquid crystal display, an organic electro-luminescence (EL) display, or the like, and is a display device for displaying various types of information.

The display unit 13 displays a video (content) provided by the video streaming system 2. The display unit 13 displays the video streamed from the video streaming system 2. The display unit 13 displays various types of information received from the information processing device 100. The display unit 13 displays an effect received from the information processing device 100. The display unit 13 displays information via an application (video streaming application) that provides a video streaming service. For example, the terminal device 10 activates the video streaming application, and displays the video by the activated video streaming application.

The storage unit 14 is implemented by, for example, a semiconductor memory element such as a Random Access Memory (RAM) and a Flash Memory, or a storage device such as a hard disk and an optical disk. The storage unit 14 stores, for example, information regarding an application installed in the terminal device 10 such as a program. For example, the storage unit 14 stores information of various applications (programs) that implement provision of the video streaming service such as output of video streaming (such as display and audio output) and an operation of providing a consideration in the video streaming.

The control unit 15 is a controller, and is implemented by, for example, a CPU, an MPU, or the like executing various programs, stored in a storage device such as the storage unit 14 inside the terminal device 10, using a RAM as a work area. For example, the various programs include a program of an application (such as the video streaming application) that performs information processing. Further, the control unit 15 is a controller, and is implemented by, for example, an integrated circuit such as an ASIC or an FPGA.

As illustrated in FIG. 5, the control unit 15 includes a reception unit 151, a transmission unit 152, and a processing unit 153, and implements or executes a function and an action of information processing to be described below. Note that, the internal configuration of the control unit 15 is not limited to the configuration illustrated in FIG. 5, and may be another configuration as long as this configuration is for performing information processing to be described later. Further, the connection relationship between the processing units included in the control unit 15 is not limited to the connection relationship illustrated in FIG. 5, and may be another connection relationship.

The reception unit 151 receives a video, provided by the video streaming system 2, via the communication unit 11. The reception unit 151 receives an effect from the information processing device 100 via the communication unit 11. Note that, the reception unit 151 may receive an effect provided by the video streaming system 2 that has received an instruction from the information processing device 100.

The transmission unit 152 transmits various types of information to an external information processing device via the communication unit 11. The transmission unit 152 transmits various types of information to the information processing device 100. The transmission unit 152 sends the information processing device 100 information indicating a consideration (provided consideration) received by the input unit 12 and provided by the user.

The transmission unit 152 transmits, to the information processing device 100, information indicating the destination, to which the consideration is to be provided, designated by the user. The transmission unit 152 sends the information processing device 100 information indicating the cast, included in the video, designated by the user.

The processing unit 153 executes various kinds of processing. The processing unit 153 displays various types of information via the display unit 13. For example, the processing unit 153 controls display on the display unit 13. The processing unit 153 outputs various types of information as audio output via the audio output unit 16. For example, the processing unit 153 controls the audio output of the audio output unit 16.

The processing unit 153 outputs the information received by the reception unit 151. The processing unit 153 outputs the video (content) provided by the video streaming system 2. The processing unit 153 causes the display unit 13 to display the video received by the reception unit 151 and causes the audio output unit 16 to output audio. The processing unit 153 displays an image via the display unit 13. The processing unit 153 outputs audio of the video via the audio output unit 16.

The processing unit 153 outputs an effect provided by the information processing device 100. The processing unit 153 displays or audio-outputs the effect received by the reception unit 151. The processing unit 153 displays the effect via the display unit 13. The processing unit 153 audio-outputs the effect via the audio output unit 16.

Note that, each processing by the control unit 15 described above may be implemented by, for example, JavaScript (registered trademark) or the like. Further, in a case where processing such as information processing by the control unit 15 described above is performed by a predetermined application, each unit of the control unit 15 may be implemented by the predetermined application, for example. For example, processing such as information processing by the control unit 15 may be implemented by control information received from an external information processing device. For example, in a case where the above-described display processing is performed by a predetermined application (such as a video streaming application), the control unit 15 may include, for example, an application control unit that controls a predetermined application or a dedicated application.

The audio output unit 16 is implemented by a speaker that outputs audio, and is an output device for outputting various types of information as audio output. The audio output unit 16 outputs the audio of the video provided by the video streaming system 2. The audio output unit 16 audio-outputs an effect provided by the information processing device 100. For example, the audio output unit 16 outputs audio corresponding to information displayed on the display unit 13.

### [1-5. Procedure of Information Processing According to Embodiment]

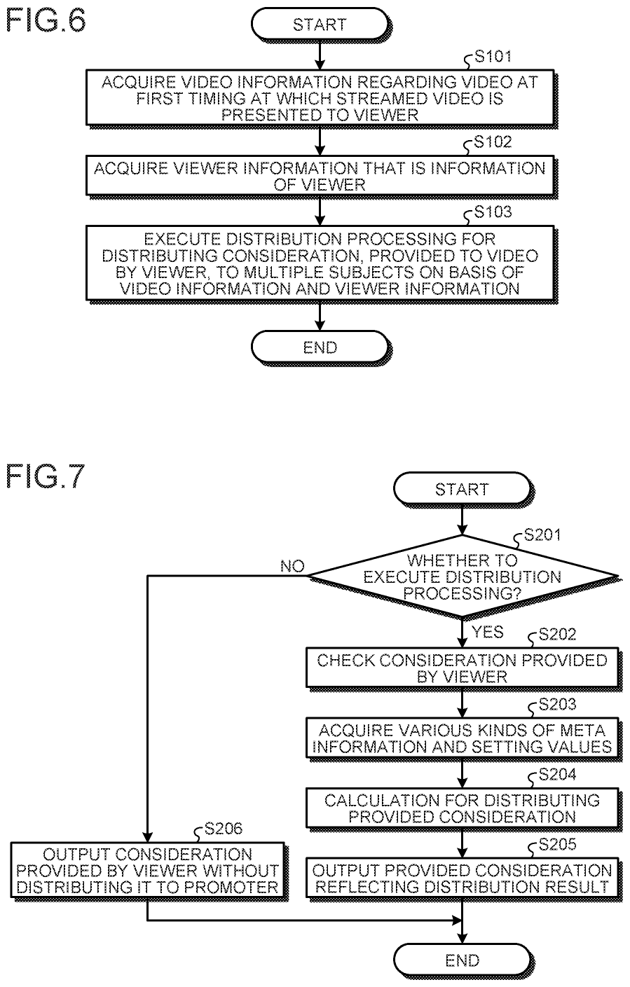

Next, a procedure of various types of information processing according to the embodiment will be described with reference to FIGS. 6 and 7.

First, a flow of processing of the information processing device according to the embodiment of the present disclosure will be described with reference to FIG. 6. FIG. 6 is a flowchart illustrating a processing procedure of the information processing device according to the embodiment of the present disclosure. Specifically, FIG. 6 is a flowchart illustrating a procedure of information processing by the information processing device 100.

As illustrated in FIG. 6, the information processing device 100 acquires video information regarding the video at the first timing at which the streamed video is presented to the viewer (Step S101). In addition, the information processing device 100 acquires viewer information that is information of the viewer (Step S102).

Then, the information processing device 100 executes distribution processing for distributing the consideration, provided to the video by the viewer, to multiple subjects on the basis of the video information and the viewer information (Step S103).

Next, FIG. 7 will be described. FIG. 7 is a flowchart illustrating a procedure related to the distribution processing. Specifically, FIG. 7 illustrates an example where the processing is branched depending on whether or not to execute the distribution processing. For example, the viewer inputs information on the consideration to the information processing device 100. In a case where the distribution system SD is used, the information processing device 100 refers to the time when the consideration has been provided and the meta information of the viewer who has provided the consideration, and performs weighted distribution calculation. With the calculation result reflected in the provided consideration, the provided consideration is output in a divided form to each party on the provision side.

As illustrated in FIG. 7, the information processing device 100 branches the processing depending on whether or not to execute the distribution processing (Step S201). The information processing device 100 branches the processing depending on whether or not to use the distribution system SD. For example, the information processing device 100 determines whether or not to execute the distribution processing according to designation of the promoter.

In a case where the distribution processing is executed (Step S201: Yes), the information processing device 100 checks the provided consideration from the viewer (Step S202). For example, the information processing device 100 checks the amount (monetary value) of the provided consideration received from the terminal device 10 of the viewer. For example, the information processing device 100 calculates, as the provided consideration, the amount of money obtained by subtracting a fee to the streaming platform (for example, the video streaming system 2) from the amount of money provided by the viewer (a distribution target amount).

The information processing device 100 acquires various kinds of meta information and setting values (Step S203). For example, the information processing device 100 acquires the video information, the viewer information, and the setting value set by the promoter.

The information processing device 100 executes calculation for distributing the provided consideration (Step S204). Then, the information processing device 100 outputs the provided consideration reflecting the distribution result (Step S205). For example, the information processing device 100 sends the device (payment server) of the payment system 5 the distribution result indicating the distribution amount to each subject calculated by the distribution processing.

On the other hand, in a case where no distribution processing is executed (Step S201: No), the information processing device 100 outputs the consideration provided by the viewer without distributing it to the promoter (Step S206). For example, the information processing device 100 sends the device (payment server) of the payment system 5 information indicating the provided consideration received from the terminal device 10 of the viewer. For example, the information processing device 100 sends the device (payment server) of the payment system 5 information indicating the amount of money obtained by subtracting a fee to the streaming platform from the amount of money provided by the viewer (the distribution target amount) as information indicating the provided consideration.

### [1-6. Processing Example]

Hereinafter, a specific example of various kinds of processing will be described. Note that, description of the same points as those described above will be omitted as appropriate.

### [1-6-1. Mode]

First, a mode regarding the distribution of the consideration provided by the viewer will be described.

The information processing device 100 of the distribution system DS may have multiple modes. As a specific example, the information processing device 100 may have three modes of the following first mode to third mode. The first mode is a manual input mode in which distribution to a stake holder engaged in live contents such as the promoter, office, and performer of the live is input manually. The second mode is a semi-automatic distribution mode in which the information processing device 100 of the distribution system DS determines a part of the distribution to the above-described stake holder. When the information processing device 100 of the distribution system DS determines the distribution, the intention of the promoter (the performer, the office to which the performer belongs, the event promoter, and the like) or the viewer is reflected with reference to the meta information given to the video, the preference information extracted from the viewing history of the viewer, and the like.

The third mode is a fully automatic distribution mode in which the information processing device 100 of the distribution system DS judges and executes all the distribution to the stake holder. At this time, the information to be referenced includes not only the above-described meta information and preference information but also the content of a contract signed inside the promoter. These modes can be selected by the system user on the provision side. Note that, the above is merely an example, and the information processing device 100 may perform only the second mode, or the information processing device 100 may determine whether to perform the first mode or the second mode and perform processing in the determined mode.

### [1-6-2. Subject (Distribution Destination)]

A video such as a live video is produced not only by the performer, the office to which the performer belongs, and the event promoter described above but also by various parties. For example, the video is produced by various parties such as a Master of Ceremony (MC) who moderates a live show, a person in charge of representation by an Augmented Reality (AR) effect or the like, a person in charge of stage decoration, a person in charge of costumes, and a character model creator in the case of a virtual YouTuber (Vtuber).

Thus, by giving the components (subjects) and the time information to the video as the meta information, the information processing system 1 can identify a party on the provision side involved in producing the video at this time. For example, in the case of a person and an effect superimposed on the face of the person in an example of the AR effect, the person and an effect creator are cited as targets to be distributed. In this case, the system user may set the distribution in advance, or the information processing device 100 may determine the distribution rate automatically (mechanically) by calculating the distribution rate from the meta information such as the viewer's reaction.

Further, in an example where there are multiple performers on a stage of a live show (event), in the case of a scene in which a specific performer (performer) appears in closeup, the information processing system 1 may set the distribution rate of the performer to be high. Furthermore, in the case of a scene in which all the performers appear, the information processing system 1 may dynamically change the distribution ratio based on the information appearing in the video so that the distribution rates of the performers are the same.

### [1-6-3. Partial Distribution Rate (Promoter, Video, Viewer)]

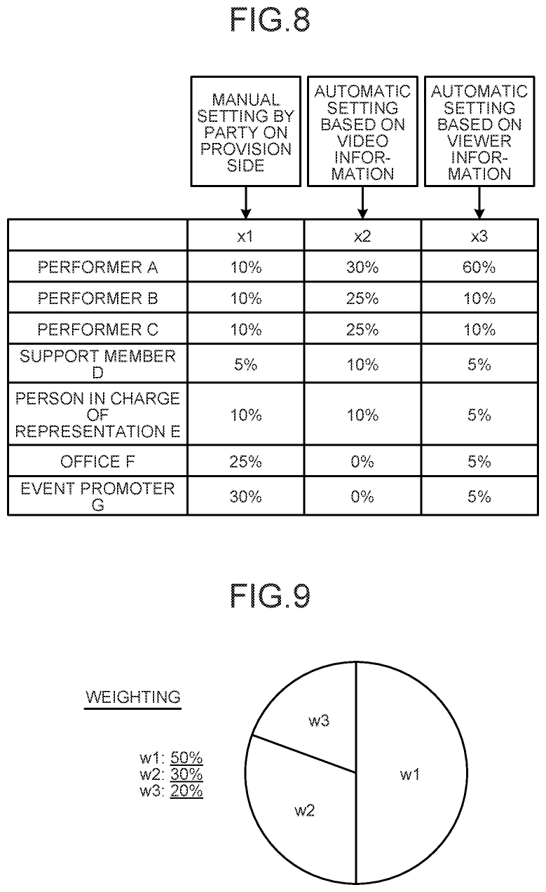

Hereinafter, a specific example of the distribution processing will be described with reference to FIGS. 8 to 10. First, an example of the partial distribution rate for each of the promoter, the video, and the viewer will be described with reference to FIG. 8. FIG. 8 is a diagram illustrating an example of the partial distribution rate. In FIG. 8, the second mode (semi-automatic distribution mode) is illustrated as an example.

The example of FIG. 8 illustrates a case where the distribution destinations are seven subjects consisting of a performer A, a performer B, a performer C, a support member D, a person in charge of representation E, an office F, and an event promoter G. For example, the seven subjects (distribution destinations) in FIG. 8 may be generated from the video information VD by the information processing device 100, or may be designated by the promoter or the like.

The distribution rate of each subject indicated by x1 (also referred to as “vector x1”) in FIG. 8 indicates a distribution rate (promoter-based distribution rate) calculated on the basis of the promoter information. FIG. 8 illustrates an example where the distribution rate of the performer A is “108” (0.1), the distribution rate of the performer B is “108,” the distribution rate of the performer C is “108,” the distribution rate of the support member D is “5%,” the distribution rate of the person in charge of representation E is “10%,” the distribution rate of the office F is “258,” and the distribution rate of the event promoter G is “30%.” For example, the vector x1 is manually set by the provider.

The distribution rate (first distribution rate) of each subject indicated by x2 (also referred to as “vector x2”) in FIG. 8 indicates a distribution rate (video-based distribution rate) calculated on the basis of the video information. FIG. 8 illustrates an example where the distribution rate of the performer A is “30%,” the distribution rate of the performer B is “25%,” the distribution rate of the performer C is “25%,” the distribution rate of the support member D is “10%,” the distribution rate of the person in charge of representation E is “10%,” the distribution rate of the office F is “0%,” and the distribution rate of the event promoter G is “0%.” For example, the vector x2 is automatically set from the video information such as the meta information of the video.

The distribution rate (second distribution rate) of each subject indicated by x3 (also referred to as “vector x3”) in FIG. 8 indicates a distribution rate (viewer-based distribution rate) calculated on the basis of the viewer information. FIG. 8 illustrates an example where the distribution rate of the performer A is “60%,” the distribution rate of the performer B is “10%,” the distribution rate of the performer C is “10%,” the distribution rate of the support member D is “58,” the distribution rate of the person in charge of representation E is “5%,” the distribution rate of the office F is “58,” and the distribution rate of the event promoter G is “5%.” For example, the vector x3 is automatically set from the viewer information such as the meta information of the viewer.

As described above, in the example of FIG. 8, the system user or the like on the provision side can manually input the vector x1 of the promoter. Meanwhile, the information processing device 100 calculates the vector x2 of the video and the vector x3 of the viewer. For example, the information processing device 100 calculates the vector x2 from the meta information of the video, and calculates the vector x3 from the meta information of the viewer.

### [1-6-4. Weighting]

Next, an example of weighting on each partial distribution rate will be described. FIG. 9 is a diagram illustrating an example of weighting. The weighting parameters w1 to w3 illustrated in FIG. 9 are weights corresponding to the respective vectors x1 to x3 in FIG. 8. For example, the proportions of the weighting parameters w1 to w3 can be determined by the provider.

The weighting parameter indicated by w1 in FIG. 9 indicates a weighting parameter (promoter weighting parameter) applied to the distribution rate (promoter-based distribution rate) calculated based on the promoter information. The example of FIG. 9 indicates that the value of the weighting parameter w1 of the promoter is “50%” (0.5).

Meanwhile, the weighting parameter indicated by w2 in FIG. 9 indicates a weighting parameter (video weighting parameter) applied to the distribution rate (video-based distribution rate) calculated based on the video information. The example of FIG. 9 indicates that the value of the weighting parameter w2 of the video is “30%”.

Meanwhile, the weighting parameter indicated by w3 in FIG. 9 indicates a weighting parameter (viewer weighting parameter) applied to the distribution rate (viewer-based distribution rate) calculated based on the viewer information. The example of FIG. 9 indicates that the value of the weighting parameter w3 of the viewer is “20%”.

Note that, the information illustrated in FIGS. 8 and 9 may be displayed on a user interface (UI) of a system used by the provided such as a promoter device. For example, the promoter may adjust the values of the vector x1 and the weighting parameters w1 to w3 by editing the information displayed in FIGS. 8 and 9.

In addition, the weighting parameter does not necessarily have to be determined by the setting by the promoter, and may be determined on the basis of various criteria. For example, the weighting parameter does not necessarily have to be determined by the manual setting, and the information processing device 100 may automatically determine the weighting parameter by using various information. For example, the information processing device 100 may determine the value of the weighting parameter on the basis of the video information or the viewer information.

For example, the information processing device 100 sets a value, obtained by dividing the sum (100%) by the number of weighting parameters, as the initial value of each weighting parameter. For example, in a case where the number of weighting parameters is “4”, the information processing device 100 sets the initial value of each weighting parameter to “25% (=100/4)”.

Then, the information processing device 100 adjusts the value of each weighting parameter by using the viewer information and the video information (target video information) related to the video at the first timing. For example, in a case where there is no performer, representation method, and the like with/in which the viewer is concerned (interested), the information processing device 100 may reduce the value of the weighting parameter of the viewer.

For example, in a case where the video at the first timing is an important scene, the information processing device 100 may increase the value of the weighting parameter of the video. For example, in a case where the target video information includes information indicating the importance level of the video at the first timing, the information processing device 100 may vary the value of the weighting parameter of the video according to the importance level of the video at the first timing. For example, in a case where the importance level of the video at the first timing is a predetermined threshold or more, the information processing device 100 may increase the value of the weighting parameter of the video and decrease the value of another weighting parameter. For example, in a case where the importance level of the video at the first timing is less than a predetermined threshold, the information processing device 100 may decrease the value of the weighting parameter of the video and increase the value of another weighting parameter. Note that, the above is merely an example, and the information processing device 100 may determine the value of the weighting parameter by appropriately using various types of information.

### [1-6-5. Distribution Processing Example]

Next, referring to FIG. 10, FIG. 10 is a diagram illustrating an example of the distribution processing. In the example illustrated in FIG. 10, a case where the distribution processing is performed on the basis of the information of FIGS. 8 and 9 will be described as an example.

In addition, FIG. 10 illustrates a case where the distribution processing is executed on the amount “1000” (yen), which is the consideration provided by a viewer Z, as illustrated in distribution processing information DT4. The information processing device 100 calculates a vector x3 illustrated in FIG. 8 from the viewer information of the viewer Z. Further, the information processing device 100 calculates a vector x2 illustrated in FIG. 8 from the video information of the video at the first timing, which is the timing (time t) at which the viewer Z provides the amount “1000” that is the provided consideration.

In FIG. 10, the performer A, the performer B, and the performer C who appear in the section corresponding to the first timing, the support member D, the person in charge of representation E who is in charge of this section, the office F to which the performers belong, and the event promoter G are set as the distribution destinations. Then, when the viewer Z provides the consideration at the first timing, the information processing device 100 executes the distribution processing with the performer A, the performer B, the performer C, the support member D, the person in charge of representation E who is in charge of this section, the office F to which the performers belong, and the event promoter G set as the distribution destinations.

The distribution processing information DT1 in FIG. 10 corresponds to the information illustrated in FIG. 8, and the distribution processing information DT2 in FIG. 10 corresponds to the information illustrated in FIG. 9. The information processing device 100 calculates the distribution rate of each subject using the distribution processing information DT1 and the distribution processing information DT2 (Step S21).

The information processing device 100 calculates a weighted average of three parameters of the vector x1 (t) corresponding to the time t, the vector x2 (t) corresponding to the time t, and the vector x3 (t) corresponding to the time t using the weighting parameters w1, w2, and w3, respectively. For example, the information processing device 100 calculates the weighted average by using the following Formula (1).

$$\overline{x ( t )} = \frac{{\sum }_{k = 1}^{n} {w}_{k} {x}_{k} ( t )}{{\sum }_{k = 1}^{n} {w}_{k}} \qquad ( 1 )$$

Here, since n=3 and w1+w2+w3=1, it can be expressed as the following Formula (2).

$$\overline{x ( t )} = {w}_{1} {x}_{1} ( t ) + {w}_{2} {x}_{2} ( t ) + {w}_{3} {x}_{3} ( t ) \qquad ( 2 )$$

The information processing device 100 calculates a vector x (t) for distribution calculation by using Formula (2). The information processing device 100 thereby calculates the distribution rate of each subject.

In FIG. 10, the information processing device 100 uses Formula (2) to calculate the distribution rate of each subject as indicated in the distribution processing information DT3. The information processing device 100 calculates “x=(26%, 14.5%, 14.58, 6.58, 9.0%, 13.5%, 16%)”. In other words, the information processing device 100 calculates that the distribution rate of the performer A is “26%,” the distribution rate of the performer B is “14.5%,” the distribution rate of the performer C is “14.5%,” the distribution rate of the support member D is “6.5%,” the distribution rate of the person in charge of representation E is “98,” the distribution rate of the office F is “13.5%,” and the distribution rate of the event promoter G is “16%.”

Then, the information processing device 100 calculates the proportion of each subject using the distribution processing information DT3 and the distribution processing information DT4 (Step S22). The information processing device 100 calculates the proportion (distribution amount) of each subject by multiplying the amount “1000” of the consideration provided by the viewer Z by the distribution rate of each subject. The information processing device 100 calculates the distribution amount of the performer A as “260” (yen), the distribution amount of the performer B as “145,” the distribution amount of the performer C as “145,” the distribution amount of the support member D as “65,” the distribution amount of the person in charge of representation E as “90,” the distribution amount of the office F as “135,” and the distribution amount of the event promoter G as “160.” Note that, the values of x1, x2, and x3 indicating the distribution rate may vary in time series.

As described above, FIG. 10 illustrates the result at a certain time t. In a case where the viewer 2 provides the consideration at the amount “1000,” the consideration provided by the viewer 2 is distributed using the calculated x such that “260” is provided to the performer A, “145” is provided to the performer B, “145” is provided to the performer C, “65” is provided to the support member D, “90” is provided to the person in charge of representation E, “135” is provided to the office F, and “160” is provided to the event promoter G.

### [1-6-6. Another Distribution Processing Example (Third Mode Etc.)]

Note that, the above-described distribution processing is merely an example, and the information processing device 100 executes the distribution processing using any information. For example, the information processing device 100 may execute the distribution processing by using the two vectors consisting of the vector x2 of the video and the vector x3 of the viewer without using the vector x1 of the promoter. In other words, the information processing device 100 may execute the distribution processing in the third mode (fully automatic distribution mode). Since the distribution processing by the information processing device 100 in this case is the same as the processing illustrated in FIG. 10, detailed description thereof will be omitted. For example, the information processing device 100 executes processing which is the same as the processing illustrated in FIG. 10 while setting the weighting parameter w2 to “60%” and the weighting parameter w3 to “40%” without using the vector x1 and the weighting parameter w1.

In addition, the information processing device 100 may execute the distribution processing without using each partial distribution rate. For example, the information processing device 100 may distribute the consideration by various types of processing using the viewer information and the video information (target video information) related to the video at the first timing. For example, the viewer information includes information (concern target information) indicating the performer, the representation method, and the like, with/in which the viewer is concerned (interested), presumed by analyzing information indicating the action history and preference of the viewer (user).

Meanwhile, for example, the target video information includes information indicating a proportion (area) of the performer, appearing in the video at the first timing, in the video. Further, the target video information includes information (subject information), indicating a person (subject) involved in the video at the time (point of time) at the first timing, as the meta information of the video. In this case, by using the subject information the information processing device 100 identifies a subject (also referred to as a “target subject”) corresponding to the video at the first timing included in the target video information.

Then, the information processing device 100 sets the distribution rate of the initial value for the identified target subject. For example, the information processing device 100 sets the initial distribution rate according to the number of target subjects serving as the distribution destinations. For example, the information processing device 100 sets a value, obtained by dividing the sum (100%) by the number of target subjects, as the initial distribution rate of each target subject. For example, in a case where the number of subjects is “5”, the information processing device 100 sets the initial distribution rate of each target subject to “20% (=100/5)”.

Then, the information processing device 100 adjusts the distribution rate of each target subject by using the viewer information and the target video information. For example, in a case where multiple performers are included in the target subject, the information processing device 100 adjusts the distribution ratio between the performers according to the proportion of each performer occupied in the video at the first timing. For example, in a case where three performers consisting of a first performer, a second performer, and a third performer are included in the target subject and the proportion of the three performers occupied in the video at the first timing is “5:3:2”, the information processing device 100 adjusts the distribution ratio so that the distribution ratio is higher in the order of the first performer, the second performer, and the third performer. In this case, the information processing device 100 may calculate the distribution rate of the first performer as “30% (=(20+20+20)*0.5)”, the distribution rate of the second performer as “18% (=60*0.3)”, and the distribution rate of the third performer as “128”. The information processing device 100 can thereby perform distribution according to the content of the video at the first timing. Note that, the information processing device 100 may adjust the entire distribution rate.

In addition, the information processing device 100 adjusts the distribution rate of each target subject by using the viewer information. The information processing device 100 adjusts the distribution rate of each target subject according to the concern of the viewer presumed from the viewer information. For example, in a case where information indicating that the viewer is interested in the third performer is included in the concern target information of the viewer, the information processing device 100 increases the distribution rate of the third performer. For example, the information processing device 100 increases the distribution rate of the third performer by decreasing the distribution rates of the four target subjects other than the third performer and adding the decrease to the distribution rate of the third performer.

For example, the information processing device decreases the distribution rates of the four target subjects other than the third performer by “5”, and adds the decreased amount “20 (=5*4)” to the distribution rate of the third performer. Note that, “5” is illustrated here as an example in order to simplify the description, but any decrease value or decrease rate may be set. In this case, the information processing device 100 calculates the distribution rate of the third performer as “32% (=12+20)”, the distribution rate of the first performer as “25% (=30-5)”, the distribution rate of the second performer as “13% (=18-5)”, and the distribution rates of the other two target subjects as “15% (=20-5)”. The information processing device 100 can thereby perform distribution according to the intention of the viewer. The above is merely an example, and the information processing device 100 calculates the distribution rate of each target subject using various information as appropriate.

### [1-6-7. Distribution Rate Determination Example (Designation of Viewer)]

Note that, the determination of the distribution rate above is merely an example, and the information processing device 100 may determine the distribution rate using various information.

For example, the viewer can also provide a consideration by designating a specific performer (cast). For example, the viewer may provide a consideration together with information designating a specific performer. For example, a consideration may be provided with an increased distribution rate to the performer A by entering “to performer A” in a comment box when inputting the consideration. In this case, a consideration may be provided with an increased distribution rate to the performer A by providing an input field for inputting a comment at the time of providing the consideration in the area AR3 of FIG. 1, or by inputting “1,000 yen to performer A” in the input field IN of FIG. 1.

For example, the information processing device 100 may determine the distribution rate in accordance with the designation by the viewer. For example, in a case where information designating the destination to which the viewer provides the consideration is received, the information processing device 100 may increase the distribution rate of the destination designated by the viewer. Further, for example, in a case where information indicating the cast, included in the video, designated by the viewer is received, the information processing device 100 may increase the distribution rate of the cast, included in the video, designated by the viewer.

[1-7. Determination of Timing when Video is Referenced]

Note that, the timing at which the viewer charges money and the timing at which the viewer refers to the video for determining the distribution rate are not necessarily the same. This is because it is conceivable that a certain period of time elapses from when the viewer wants to charge money until he/she completes the charging. The following two examples are conceivable as examples in which the two timings are not the same.

### [1-7-1. First Example]

First, as a first example, by the viewer's operation, the information processing device 100 determines the timing when the video is referenced. For example, the information processing device 100 may determine the first timing on the basis of an operation of the terminal device 10 by the viewer. For example, the information processing device 100 may determine the timing, at which the viewer desires to perform the charging, by the viewer's operation of a touch panel of a smartphone, a mouse of a PC, or the like. Alternatively, at the time of charging, the viewer may input the timing at which the viewer wants to charge money, such as o:oo. In this case, for example, the information processing device 100 determines, as the first timing, the timing indicated by the information input by the viewer. Meanwhile, in an example of a remote live show in which the input/transmission of face marks and the input of comments are possible, the information processing device 100 may presume the timing at which the inputs are made and the timing at which the number of times of inputs is remarkable as the timing at which the viewer wants to charge money. For example, the information processing device 100 may determine the distribution rate of the charging by referring to the video streamed at the timing determined in this manner.

### [1-7-2. Second Example]

Meanwhile, as a second example, the information processing device 100 determines the timing when the video is referenced on the basis of the biological information. For example, the information processing device 100 may determine the first timing on the basis of the biological information detected by the terminal device 10 used by the viewer. For example, the information processing device 100 may acquire the biological information and reactions of the audience using a wearable device worn by the viewer or a peripheral device, and presume the timing at which the audience wants to charge money on the basis of these pieces of information. Examples of sensors that acquire the biological information include a heart rate sensor, a blood pressure sensor, a perspiration sensor, a body temperature sensor, a camera, and a microphone. A motion sensor includes, for example, an acceleration sensor, a gyro sensor, a vibration sensor, and the like, and acquires behavior information regarding the movement of the viewer.

For example, the information processing device 100 may determine, as the first timing, the timing at which the value indicated by the biological information exceeds a predetermined value. For example, in a case where the heart rate obtained by the heart rate sensor or the body temperature obtained by the body temperature sensor rapidly increases or exceeds a threshold, it is possible to presume that the viewer is excited by viewing the streamed video.

Thus, the information processing device 100 may refer to the streamed video at this timing. For example, the information processing device 100 may determine, as the first timing, the timing at which the viewer's heart rate or body temperature exceeds a predetermined value. Besides, in a case where the motion sensor shows that the viewer makes a large gesture, it is possible to presume that the viewer is excited by viewing the streamed video. In a case where the timing is determined on the basis of a threshold, the threshold may be a predetermined value or may be determined by an average value of the biological information of the viewer or the like.

### [1-8. Payment Timing Example]

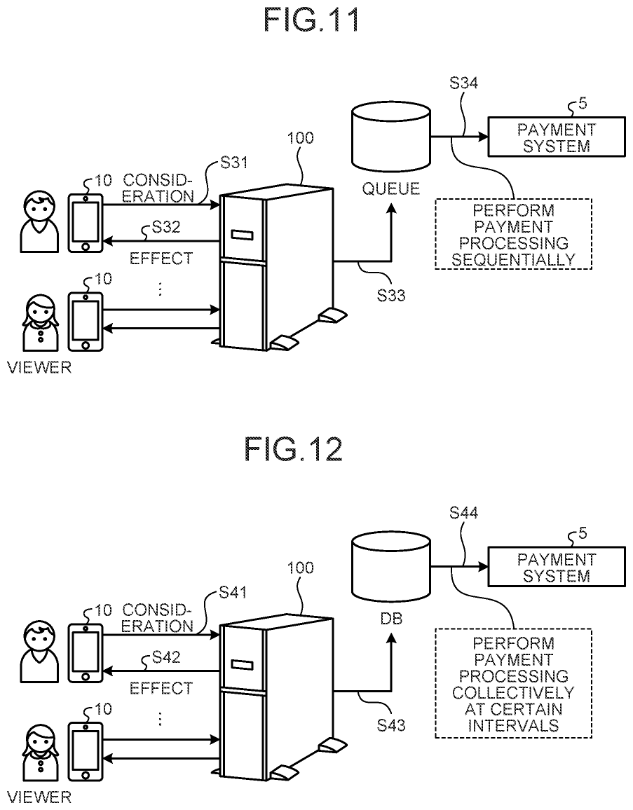

From here, an example of the timing (payment timing) at which payment of the provided consideration of the information processing system 1 described above is made will be described with reference to FIGS. 11 and 12. FIG. 11 is a diagram illustrating an example of a first pattern related to payment timing. Meanwhile, FIG. 12 is a diagram illustrating an example of a second pattern related to payment timing. Note that, the payment timing is not limited to the first pattern and the second pattern illustrated in FIGS. 11 and 12, and any pattern can be employed.

First, in the information processing system 1, when the viewer provides a consideration, an effect occurs in response to the consideration. For example, assuming that provision of the consideration is performed in cooperation with the payment system 5 and no consideration is provided unless the processing with the payment system is completed successfully, it depends on the situation of the network and other transactions and therefore it is difficult to display a real-time effect for thrown money.

To deal with this, the information processing system 1 executes the following payment processing in the first pattern or the second pattern. That is, the information processing system 1 performs payment processing separately from effect processing in response to provision of the consideration.

### [1-8-1. First Pattern]

First, the first pattern will be described with reference to FIG. 11. In a case where the viewer has provided a consideration (Step S31), the information processing device 100 immediately displays an effect corresponding thereto on the terminal device 10 of the viewer (Step S32).

On the other hand, in the information processing system 1, tasks of the payment processing are separately managed by queues (Step S33) and sequentially processed (Step S34). Note that, the information processing device 100 may include queues, and the information processing device 100 may sequentially transmit the payment information stored in the queues to the payment system 5.

### [1-8-2. Second Pattern]

Next, the second pattern will be described with reference to FIG. 12. In a case where the viewer has provided a consideration (Step S41), the information processing device 100 immediately displays an effect corresponding thereto on the terminal device 10 of the viewer (Step S42).

On the other hand, in the information processing system 1, the value of the total amount of the provided consideration is held in a database DB for each viewer (Step S43), and the payment processing is performed collectively at certain intervals (Step S44). Note that, the information processing device 100 may include the database DB, and the information processing device 100 may transmit the payment information, stored in the database DB, to the payment system 5 collectively at certain intervals.

In the information processing system 1, by performing the payment processing in the first pattern or the second pattern described above, the viewer can receive the response of the effect immediately after providing the consideration, thereby improving the user experience.

### 2. Other Embodiments

The processing according to each of the above-described embodiments may be performed in various different forms (modifications) other than the above-described embodiments and modifications.

### [2-1. Other Configuration Examples]

The device configuration of the information processing system 1 described above is merely an example, and the information processing system 1 can employ any device configuration as long as the above-described video streaming, distribution processing, and the like can be executed.

### [2-2. Others]

Among the processing described in the above embodiments, all or a part of the processing described as being automatically performed can be manually performed, or all or a part of the processing described as being manually performed can be automatically performed by a known method. Besides, the processing procedure, specific name, and information including various data and parameters illustrated in the above document and drawings can be arbitrarily changed unless otherwise specified. For example, the various types of information illustrated in the drawings are not limited to the illustrated information.

In addition, each component of each device illustrated in the drawings is functionally conceptual, and is not necessarily physically configured as illustrated in the drawings. In other words, the specific form of distribution and integration of each device is not limited to the illustrated form, and all or a part of the device can be functionally or physically distributed and integrated in an arbitrary unit according to various loads, usage conditions, and the like.

In addition, the above-described embodiment and modifications can be appropriately combined within a range that does not contradict processing contents.

Further, the effects described in this specification are merely examples and are not limited, and other effects may be provided.

### 3. Effects According to Present Disclosure

As described above, the information processing device (the information processing device 100 in the embodiment) according to the present disclosure includes the video information acquisition unit (the video information acquisition unit 132 in the embodiment), the viewer information acquisition unit (the viewer information acquisition unit 133 in the embodiment), and the processing unit (the processing unit 135 in the embodiment). The video information acquisition unit acquires the video information on the video at the first timing at which the streamed video is presented to the viewer. The viewer information acquisition unit acquires the viewer information which is information on the viewer. The processing unit performs the distribution processing for distributing the consideration, provided to the video by the viewer, to multiple subjects based on the video information and the viewer information.

As described above, the information processing device according to the present disclosure can appropriately distribute the consideration provided by the viewer by performing the distribution processing for distributing the consideration, provided by the viewer, to the multiple subjects using the information on the video and the information on the viewer who has provided the consideration.

Meanwhile, the processing unit distributes the consideration to the multiple subjects, which provide the video, based on the video information and the viewer information. In this manner, the information processing device can appropriately distribute the consideration provided by the viewer by distributing the consideration to the multiple subjects which provide the video.

Further, the processing unit distributes the consideration to the multiple subjects including at least one of the cast in the video, the organization to which the cast in the video belongs, and the event promoter of the video. In this manner, the information processing device can appropriately distribute the consideration provided by the viewer by distributing the consideration to the multiple subjects such as the cast in the video, the organization (such as an office) to which the cast belongs, and the event promoter of the video.

Meanwhile, the video information acquisition unit acquires the video information including information indicating the cast in the video. The processing unit distributes the consideration based on information indicating the cast in the video. In this manner, the information processing device can appropriately distribute the consideration provided by the viewer by distributing the consideration based on the cast in the video.

Further, the video information acquisition unit acquires the video information including information indicating the cast included in the video at the first timing. The processing unit distributes the consideration on the basis of information indicating the cast included in the video at the first timing. In this manner, the information processing device distributes the consideration on the basis of the cast included in the video at the timing when the viewer provides the consideration, thereby enabling the distribution reflecting the viewer's intention. Thus, the information processing device can appropriately distribute the consideration provided by the viewer.

Meanwhile, the viewer information acquisition unit acquires the viewer information including an action history of the viewer. The processing unit distributes the consideration based on the action history of the viewer. In this manner, the information processing device distributes the consideration based on the action history of the viewer, thereby enabling the distribution reflecting the tendency of the viewer's action. Thus, the information processing device can appropriately distribute the consideration provided by the viewer.

Meanwhile, the viewer information acquisition unit acquires the viewer information including information indicating the preference of the viewer. The processing unit distributes the consideration based on the information indicating the preference of the viewer. In this manner, the information processing device distributes the consideration based on the action history of the viewer, thereby enabling the distribution reflecting the preference of the viewer. Thus, the information processing device can appropriately distribute the consideration provided by the viewer.

Meanwhile, the processing unit calculates a distribution rate of the consideration based on the video information and the viewer information, and distributes the consideration on the basis of the calculated distribution rate of the consideration. In this manner, the information processing device can appropriately distribute the consideration provided by the viewer by distributing the consideration based on the calculated distribution rate of the consideration.

Meanwhile, the processing unit calculates the distribution rate of the consideration by using a first distribution rate calculated based on the video information and a second distribution rate calculated based on the viewer information. In this manner, by using the first distribution rate calculated based on the video information and the second distribution rate calculated based on the viewer information, the information processing device can calculate the distribution rate of the consideration while taking these pieces of information into consideration comprehensively. Thus, the information processing device can appropriately distribute the consideration provided by the viewer.

In addition, the processing unit calculates the distribution rate of the consideration using information indicating the weights of the first distribution rate and the second distribution rate. In this manner, the information processing device can adjust the influence of each distribution rate according to the importance level or the like of the distribution rate by using the weights of the first distribution rate and the second distribution rate. Thus, the information processing device can appropriately distribute the consideration provided by the viewer.

Meanwhile, the processing unit calculates the distribution rate of the consideration by using a first weighting parameter indicating the weight of the first distribution rate and a second weighting parameter indicating the weight of the second distribution rate. In this manner, the information processing device can adjust the influence of each distribution rate according to the importance level or the like of the distribution rate by using the first weighting parameter of the first distribution rate and the second weighting parameter of the second distribution rate. Thus, the information processing device can appropriately distribute the consideration provided by the viewer.

Meanwhile, the processing unit calculates the distribution rate of the consideration by calculating a weighted average using the first distribution rate, the second distribution rate, the first weighting parameter, and the second weighting parameter. In this manner, by calculating the weighted average, the information processing device can calculate the distribution rate of the consideration in consideration of the importance level of each piece of information. Thus, the information processing device can appropriately distribute the consideration provided by the viewer.

Meanwhile, the processing unit calculates the distribution rate of the consideration by using the first weighting parameter and the second weighting parameter that are determined based on criteria regarding the video and the viewer. In this manner, by using the first weighting parameter and the second weighting parameter that are determined based on the criteria regarding the video and the viewer, the information processing device can adjust the influence of each distribution rate according to the criteria. Thus, the information processing device can appropriately distribute the consideration provided by the viewer.

Meanwhile, the processing unit determines the first timing based on biological information of the viewer. In this manner, the information processing device determines the first timing based on the biological information of the viewer, and thus can distribute the consideration, provided by the viewer, with reference to the video at an appropriate timing.

Meanwhile, the biological information is acquired by the sensor. In this manner, the information processing device can appropriately distribute the consideration provided by the viewer by using the biological information acquired by the sensor.

Meanwhile, the processing unit determines, as the first timing, the timing at which the biological information exceeds a predetermined value. In this manner, the information processing device determines, as the first timing, the timing at which the biological information exceeds the predetermined value, and thus can distribute the consideration, provided by the viewer, with reference to the video at an appropriate timing.

Meanwhile, the information processing device includes the promoter information acquisition unit (the promoter information acquisition unit 134 in the embodiment) that acquires promoter information on a promoter of the video. The processing unit distributes the consideration based on the promoter information. In this manner, the information processing device can distribute the consideration in consideration of a factor related to the promoter of the video. Thus, the information processing device can appropriately distribute the consideration provided by the viewer.

Meanwhile, the promoter information acquisition unit acquires the promoter information including the setting by the promoter. The processing unit distributes the consideration based on the setting made by the promoter. In this manner, the information processing device can distribute the consideration based on the setting made by the promoter, thereby enabling the distribution reflecting the promoter's intention. Thus, the information processing device can appropriately distribute the consideration provided by the viewer.

Meanwhile, the information processing device includes the reception unit (the reception unit 131 in the embodiment) that receives the consideration provided by the viewer. The processing unit distributes the consideration from the viewer received by the reception unit. In this manner, the information processing device can appropriately distribute the consideration provided by the viewer by receiving the consideration provided by the viewer and distributing the received consideration.

Meanwhile, the reception unit receives information indicating the destination, to which the consideration is to be provided, designated by the viewer. The processing unit distributes the consideration while increasing the distribution rate of the destination designated by the viewer. In this manner, the information processing device receives designation of the destination, to which the consideration is to be provided, by the viewer, and increases the distribution rate of the destination designated by the viewer, thereby enabling distribution reflecting the viewer's intention. Thus, the information processing device can appropriately distribute the consideration provided by the viewer.

Meanwhile, the reception unit receives information indicating the cast, included in the video, designated by the viewer. The processing unit distributes the consideration while increasing the distribution rate of the cast, included in the video, designated by the viewer. In this manner, the information processing device receives designation of the cast, included in the video, by the viewer, and increases the distribution rate of the cast designated by the viewer, thereby enabling distribution reflecting the viewer's intention. Thus, the information processing device can appropriately distribute the consideration provided by the viewer.

### 4. Hardware Configuration

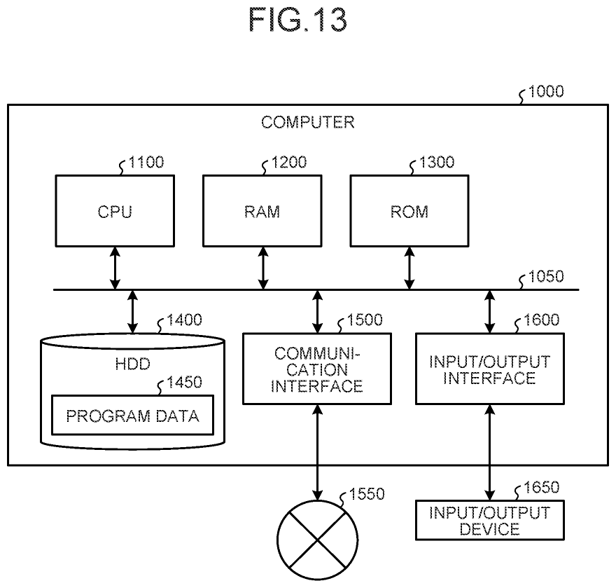

The information processing device (information device) such as the information processing device 100 and the terminal device 10 according to each embodiment described above is implemented by a computer 1000 having a configuration as illustrated in FIG. 13, for example. FIG. 13 is a hardware configuration diagram illustrating an example of the computer 1000 that implements functions of the information processing device. Hereinafter, the information processing device 100 according to the embodiment will be described as an example. The computer 1000 includes a CPU 1100, a RAM 1200, a Read Only Memory (ROM) 1300, a Hard Disk Drive (HDD) 1400, a communication interface 1500, and an input/output interface 1600. These units of the computer 1000 are connected to each other by a bus 1050.

The CPU 1100 operates on the basis of programs stored in the ROM 1300 or the HDD 1400, and controls each unit. For example, the CPU 1100 develops programs stored in the ROM 1300 or the HDD 1400 on the RAM 1200, and executes processing corresponding to the various programs.

The ROM 1300 stores a boot program such as a Basic Input Output System (BIOS) executed by the CPU 1100 when the computer 1000 is activated, a program dependent on hardware of the computer 1000, and the like.

The HDD 1400 is a computer-readable recording medium that non-transiently records a program executed by the CPU 1100, data used by the program, and the like. Specifically, the HDD 1400 is a recording medium that records an information processing program according to this disclosure as an example of program data 1450.

The communication interface 1500 is an interface for the computer 1000 to be connected to an external network 1550 (for example, the Internet). For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 receives data from an input device such as a keyboard and a mouse via the input/output interface 1600. In addition, the CPU 1100 transmits data to an output device such as a display, a speaker, and a printer via the input/output interface 1600. Further, the input/output interface 1600 may function as a media interface that reads a program and the like recorded in a predetermined recording medium (medium). The medium is, for example, an optical recording medium such as a Digital Versatile Disc (DVD) or a Phase change rewritable Disk (PD), a magneto-optical recording medium such as a Magneto-Optical disk (MO), a tape medium, a magnetic recording medium, a semiconductor memory, and the like.

For example, in a case where the computer 1000 functions as the information processing device 100 according to the embodiment, the CPU 1100 of the computer 1000 implements the functions of the control unit 130 and the like by executing the information processing program loaded on the RAM 1200. In addition, the HDD 1400 stores the information processing program according to the present disclosure and data in the storage unit 120. Note that, the CPU 1100 reads the program data 1450 from the HDD 1400 and executes the program data, but as another example, these programs may be acquired from another device via the external network 1550.

Note that, the present technique can also have the following configuration.

(1)

An information processing device comprising:
a video information acquisition unit that acquires video information on a video at a first timing at which a streamed video is presented to a viewer;
a viewer information acquisition unit that acquires viewer information which is information on the viewer; and
a processing unit that performs distribution processing for proportionally distributing a consideration, provided to the video by the viewer, to a plurality of subjects based on the video information and the viewer information.
   (2)

The information processing device according to (1), wherein,
based on the video information and the viewer information, the processing unit proportionally distributes the consideration to the plurality of subjects, which provide the video, including at least one of a cast in the video, an organization to which the cast in the video belongs, and an event promoter of the video.
   (3)

The information processing device according to (1) or (2), wherein
the video information acquisition unit acquires the video information including information indicating a cast in the video, and
the processing unit proportionally distributes the consideration based on the information indicating the cast in the video.
   (4)

The information processing device according to any one of (1) to (3), wherein
the viewer information acquisition unit acquires the viewer information including an action history of the viewer, and
the processing unit proportionally distributes the consideration based on the action history of the viewer.
   (5)

The information processing device according to any one of (1) to (4), wherein
the viewer information acquisition unit acquires the viewer information including information indicating a preference of the viewer, and
the processing unit proportionally distributes the consideration based on the information indicating the preference of the viewer.
   (6)

The information processing device according to any one of (1) to (5), wherein
the processing unit calculates a distribution rate of the consideration based on the video information and the viewer information, and proportionally distributes the consideration based on the calculated distribution rate of the consideration.
   (7)

The information processing device according to (6), wherein
the processing unit calculates the distribution rate of the consideration by using a first distribution rate calculated based on the video information, a second distribution rate calculated based on the viewer information, and information indicating weights of the first distribution rate and the second distribution rate.
   (8)

The information processing device according to (7), wherein
the processing unit calculates the distribution rate of the consideration by using a first weighting parameter indicating the weight of the first distribution rate and a second weighting parameter indicating the weight of the second distribution rate.
   (9)

The information processing device according to (8), wherein
the processing unit calculates the distribution rate of the consideration by calculating a weighted average using the first distribution rate, the second distribution rate, the first weighting parameter, and the second weighting parameter.
   (10)

The information processing device according to (8) or (9), wherein
the processing unit calculates the distribution rate of the consideration by using the first weighting parameter and the second weighting parameter that are determined based on criteria regarding the video and the viewer.
   (11)

The information processing device according to any one of (1) to (10), wherein
the processing unit determines the first timing based on biological information of the viewer.
   (12)

The information processing device according to (11), wherein
the biological information is acquired by a sensor.
   (13)

The information processing device according to (11) or (12), wherein
the processing unit determines, as the first timing, a timing at which the biological information exceeds a predetermined value.
   (14)

The information processing device according to any one of (1) to (13), further comprising a promoter information acquisition unit that acquires promoter information on a promoter of the video, wherein
the processing unit proportionally distributes the consideration based on the promoter information.
   (15)

The information processing device according to (14), wherein
the promoter information acquisition unit acquires the promoter information including setting by the promoter, and
the processing unit proportionally distributes the consideration based on the setting made by the promoter.
   (16)

The information processing device according to any one of (1) to (15), further comprising
a reception unit that receives the consideration provided by the viewer, wherein
the processing unit proportionally distributes the consideration from the viewer received by the reception unit.
   (17)

The information processing device according to (16), wherein
the reception unit receives information indicating the destination, to which the consideration is to be provided, designated by the viewer, and
the processing unit proportionally distributes the consideration while increasing the distribution rate of the destination designated by the viewer.
   (18)

The information processing device according to (16) or (17), wherein
the reception unit receives information indicating a cast, included in the video, designated by the viewer, and
the processing unit proportionally distributes the consideration while increasing the distribution rate of the cast, included in the video, designated by the viewer.
   (19)

An information processing method executed by a computer, the method comprising:
acquiring video information on a video at a first timing at which a streamed video is presented to a viewer;
acquiring viewer information which is information on the viewer; and
performing distribution processing for proportionally distributing a consideration, provided to the video by the viewer, to a plurality of subjects based on the video information and the viewer information.
   (20)

A non-transitory computer-readable storage medium storing an information processing program for causing a computer to execute processing of:
acquiring video information on a video at a first timing at which a streamed video is presented to a viewer;
acquiring viewer information which is information on the viewer; and
performing distribution processing for proportionally distributing a consideration, provided to the video by the viewer, to a plurality of subjects based on the video information and the viewer information.

### REFERENCE SIGNS LIST

1 INFORMATION PROCESSING SYSTEM
100 INFORMATION PROCESSING DEVICE
110 COMMUNICATION UNIT
120 STORAGE UNIT
121 VIDEO INFORMATION STORAGE UNIT
122 VIEWER INFORMATION STORAGE UNIT
123 PROMOTER INFORMATION STORAGE UNIT
124 WEIGHT INFORMATION STORAGE UNIT
130 CONTROL UNIT
131 RECEPTION UNIT
132 VIDEO INFORMATION ACQUISITION UNIT
133 VIEWER INFORMATION ACQUISITION UNIT
134 PROMOTER INFORMATION ACQUISITION UNIT
135 PROCESSING UNIT
136 OUTPUT UNIT
10 TERMINAL DEVICE
11 COMMUNICATION UNIT
12 INPUT UNIT
13 DISPLAY UNIT
14 STORAGE UNIT
15 CONTROL UNIT
151 RECEPTION UNIT
152 TRANSMISSION UNIT
153 PROCESSING UNIT
16 AUDIO OUTPUT UNIT

1. An information processing device comprising:
a video information acquisition unit that acquires video information on a video at a first timing at which a streamed video is presented to a viewer;
a viewer information acquisition unit that acquires viewer information which is information on the viewer; and
a processing unit that performs distribution processing for proportionally distributing a consideration, provided to the video by the viewer, to a plurality of subjects based on the video information and the viewer information.

2. The information processing device according to claim 1, wherein,
based on the video information and the viewer information, the processing unit proportionally distributes the consideration to the plurality of subjects, which provide the video, including at least one of a cast in the video, an organization to which the cast in the video belongs, and an event promoter of the video.

3. The information processing device according to claim 1, wherein
the video information acquisition unit acquires the video information including information indicating a cast in the video, and
the processing unit proportionally distributes the consideration based on the information indicating the cast in the video.

4. The information processing device according to claim 1, wherein
the viewer information acquisition unit acquires the viewer information including an action history of the viewer, and
the processing unit proportionally distributes the consideration based on the action history of the viewer.

5. The information processing device according to claim 1, wherein
the viewer information acquisition unit acquires the viewer information including information indicating a preference of the viewer, and
the processing unit proportionally distributes the consideration based on the information indicating the preference of the viewer.

6. The information processing device according to claim 1, wherein
the processing unit calculates a distribution rate of the consideration based on the video information and the viewer information, and proportionally distributes the consideration based on the calculated distribution rate of the consideration.

7. The information processing device according to claim 6, wherein
the processing unit calculates the distribution rate of the consideration by using a first distribution rate calculated based on the video information, a second distribution rate calculated based on the viewer information, and information indicating weights of the first distribution rate and the second distribution rate.

8. The information processing device according to claim 7, wherein
the processing unit calculates the distribution rate of the consideration by using a first weighting parameter indicating the weight of the first distribution rate and a second weighting parameter indicating the weight of the second distribution rate.

9. The information processing device according to claim 8, wherein
the processing unit calculates the distribution rate of the consideration by calculating a weighted average using the first distribution rate, the second distribution rate, the first weighting parameter, and the second weighting parameter.

10. The information processing device according to claim 8, wherein
the processing unit calculates the distribution rate of the consideration by using the first weighting parameter and the second weighting parameter that are determined based on criteria regarding the video and the viewer.

11. The information processing device according to claim 1, wherein
the processing unit determines the first timing based on biological information of the viewer.

12. The information processing device according to claim 11, wherein
the biological information is acquired by a sensor.

13. The information processing device according to claim 11, wherein
the processing unit determines, as the first timing, a timing at which the biological information exceeds a predetermined value.

14. The information processing device according to claim 1, further comprising a promoter information acquisition unit that acquires promoter information on a promoter of the video, wherein
the processing unit proportionally distributes the consideration based on the promoter information.

15. The information processing device according to claim 14, wherein
the promoter information acquisition unit acquires the promoter information including setting by the promoter, and
the processing unit proportionally distributes the consideration based on the setting made by the promoter.

16. The information processing device according to claim 1, further comprising
a reception unit that receives the consideration provided by the viewer, wherein
the processing unit proportionally distributes the consideration from the viewer received by the reception unit.

17. The information processing device according to claim 16, wherein
the reception unit receives information indicating the destination, to which the consideration is to be provided, designated by the viewer, and
the processing unit proportionally distributes the consideration while increasing the distribution rate of the destination designated by the viewer.

18. The information processing device according to claim 16, wherein
the reception unit receives information indicating a cast, included in the video, designated by the viewer, and
the processing unit proportionally distributes the consideration while increasing the distribution rate of the cast, included in the video, designated by the viewer.

19. An information processing method executed by a computer, the method comprising:
acquiring video information on a video at a first timing at which a streamed video is presented to a viewer;
acquiring viewer information which is information on the viewer; and
performing distribution processing for proportionally distributing a consideration, provided to the video by the viewer, to a plurality of subjects based on the video information and the viewer information.

20. A non-transitory computer-readable storage medium storing an information processing program for causing a computer to execute processing of:
acquiring video information on a video at a first timing at which a streamed video is presented to a viewer;
acquiring viewer information which is information on the viewer; and
performing distribution processing for proportionally distributing a consideration, provided to the video by the viewer, to a plurality of subjects based on the video information and the viewer information.
